(19) United States
(12) Patent Application Publication
(10) Pub. No.: US 2023/0384912 A1
(43) Pub. Date: Nov. 30, 2023

(54) METHODS FOR PROVIDING DYNAMIC SELECTION OF CONTENTS IN A GRAPHICAL USER INTERFACE AND DEVICES THEREOF

(71) Applicant: Siemens Healthcare GmbH, Erlangen (DE)

(72) Inventors: Egan Schulz, San Jose, CA (US); Erin Ballard, La Honda, CA (US)

(21) Appl. No.: 17/664,877

(22) Filed: May 25, 2022

(51) Int. Cl. G06F 3/0484; G06F 3/0482

(52) U.S. Cl. CPC G06F 3/0484; G06F 3/0482

(57) ABSTRACT

Embodiments provide a system and method for providing dynamic selection in a graphical user interface. The system and method display one or more selections of content data and an operation to be performed on the one or more selections of the content data, on a graphical user interface. The system and method receive one or more changes to the displayed one or more selections of content data. The system and method display the received one or more changes while retaining the displayed one or more selections of the content data and the operation to be performed on the displayed one or more selections of the content data, on the graphical user interface.

### TECHNICAL FIELD

This technology generally relates to methods and devices for managing contents in a graphical user interface and, more particularly, to methods for providing dynamic selection of contents in a graphical user interface and devices thereof.

### BACKGROUND

Use of graphical user interface as an input and/or output medium has significantly increased in the recent years. In existing technologies, a user first selects the content on a graphical user interface and then selects an action that is to be performed on the selected content. Generally the action that is required to be performed can be selected by a right click operation on the mouse which results in a dialog box being displayed on the graphical user interface. However, when the user determines that not all the content is selected to perform the operation, the user will have to cancel the dialog box. Once the dialog box is cancelled, the user may have to re-select all the contents in addition to the forgotten contents (i.e., the contents not selected by the previous operation). By way of example, if a user selects a large number of files from a very long list of files to be deleted, it would be highly inefficient to cancel out of the deletion and re-select those items simply because some items were forgotten.

In another example, if the user realizes that a particular content should not have been selected, then the user may need to start the selection process completely over after cancelling out the dialog selection box. However, existing technology is inefficient when there are a large number of selections that need to be re-performed.

Some conventional solutions maintain the selection of the items previously selected after the dialog box has been cancelled. However, this solution still requires the user to go back through the dialog box selection process, which can be time consuming and tedious, especially in the case in which the desired dialog box is not easily accessible (e.g., the desired dialog box is nested many levels from the initial selection point).

### SUMMARY

Embodiments of the present invention address and overcome one or more of the above shortcomings and drawbacks by providing methods, systems, and apparatuses related to providing dynamic selection of contents in a graphical user interface. Briefly, the techniques described herein include displaying one or more selections of content data and an operation to be performed on the one or more selections of the content data, on a graphical user interface. Next, one or more changes to the displayed one or more selections of content data is received. The received one or more changes is displayed while retaining the displayed one or more selections of the content data and the operation to be performed on the displayed one or more selections of the content data, on the graphical user interface.

A method for providing dynamic selection in a graphical user interface includes displaying by a computing device one or more selections of content data and an operation to be performed on the one or more selections of the content data, on a graphical user interface. One or more changes to the displayed one or more selections of content data is received by the computing device. The received one or more changes is displayed by the computing device while retaining the displayed one or more selections of the content data and the operation to be performed on the displayed one or more selections of the content data, on the graphical user interface. Additionally in this example, the one or more selections of the content data and the operation to be performed is cached by the computing device, wherein the cached one or more selections of the content data is used to display the received one or more changes while retaining the displayed one or more selections of the content data and the operation to be performed. Further, in this example, the operation is performed by the computing device after displaying the received one or more changes while retaining the displayed one or more selections of the content data. Furthermore in this example, the received one or more changes is cached by the computing device prior to displaying the received one or more changes while retaining the displayed one or more selections of the content data and the operation to be performed on the displayed one or more selections of the content data. Also, in this example, one or more operation changes to the operation to be performed on the one or more selections of the content data is received by the computing device. The received one or more operation changes are then displayed by the computing device while retaining the display of the received one or more changes and the display of the one or more selections of the content data.

A non-transitory computer readable medium having stored thereon instructions for providing dynamic selection of contents in a graphical user interface comprising executable code, which when executed by at least one processor, cause the processor to display one or more selections of content data and an operation to be performed on the one or more selections of the content data, on a graphical user interface. One or more changes to the displayed one or more selections of content data is received. The received one or more changes is displayed by the computing device while retaining the displayed one or more selections of the content data and the operation to be performed on the displayed one or more selections of the content data, on the graphical user interface. Additionally in this example, the one or more selections of the content data and the operation to be performed is cached and the cached one or more selections of the content data is used to display the received one or more changes while retaining the displayed one or more selections of the content data and the operation to be performed. Further, in this example, the operation is performed after displaying the received one or more changes while retaining the displayed one or more selections of the content data. Furthermore in this example, the received one or more changes is cached prior to displaying the received one or more changes while retaining the displayed one or more selections of the content data and the operation to be performed on the displayed one or more selections of the content data. Also, in this example, one or more operation changes to the operation to be performed on the one or more selections of the content data is received. The received one or more operation changes are then displayed while retaining the display of the received one or more changes and the display of the one or more selections of the content data.

A computing device comprising a processor and a memory coupled to the processor which is configured to be capable of executing programmed instructions comprising and stored in the memory to display one or more selections of content data and an operation to be performed on the one or more selections of the content data, on a graphical user interface. One or more changes to the displayed one or more selections of content data is received. The received one or more changes is displayed by the computing device while retaining the displayed one or more selections of the content data and the operation to be performed on the displayed one or more selections of the content data, on the graphical user interface. Additionally in this example, the one or more selections of the content data and the operation to be performed is cached and the cached one or more selections of the content data is used to display the received one or more changes while retaining the displayed one or more selections of the content data and the operation to be performed. Further, in this example, the operation is performed after displaying the received one or more changes while retaining the displayed one or more selections of the content data. Furthermore in this example, the received one or more changes is cached prior to displaying the received one or more changes while retaining the displayed one or more selections of the content data and the operation to be performed on the displayed one or more selections of the content data. Also, in this example, one or more operation changes to the operation to be performed on the one or more selections of the content data is received. The received one or more operation changes are then displayed while retaining the display of the received one or more changes and the display of the one or more selections of the content data.

Additional features and advantages of this disclosure will be made apparent from the following detailed description of illustrative embodiments that proceeds with reference to the accompanying drawings.

### BRIEF DESCRIPTION OF THE DRAWINGS

FIG. 1 is a block diagram of a network environment including an example of an interface management computing apparatus for providing dynamic selection of contents in a graphical user interface;

FIG. 2 is an exemplary block diagram of the interface management computing apparatus;

FIG. 3 is an exemplary flowchart of a method for providing dynamic selection of contents in a graphical user interface; and

FIGS. 4-5 are exemplary images of the graphical user interface with the selected contents and the operation.

### DETAILED DESCRIPTION

The following disclosure describes the present invention according to several embodiments directed at methods, systems, and apparatuses related to providing dynamic selection of contents in a graphical user interface. More specifically, the techniques described herein allow the user to add and delete selections while a dialog box is still active. Using these techniques, performance and efficiency of graphical user interfaces is improved because there is no longer a need to cancel out of the dialog box to modify selections to be processed further.

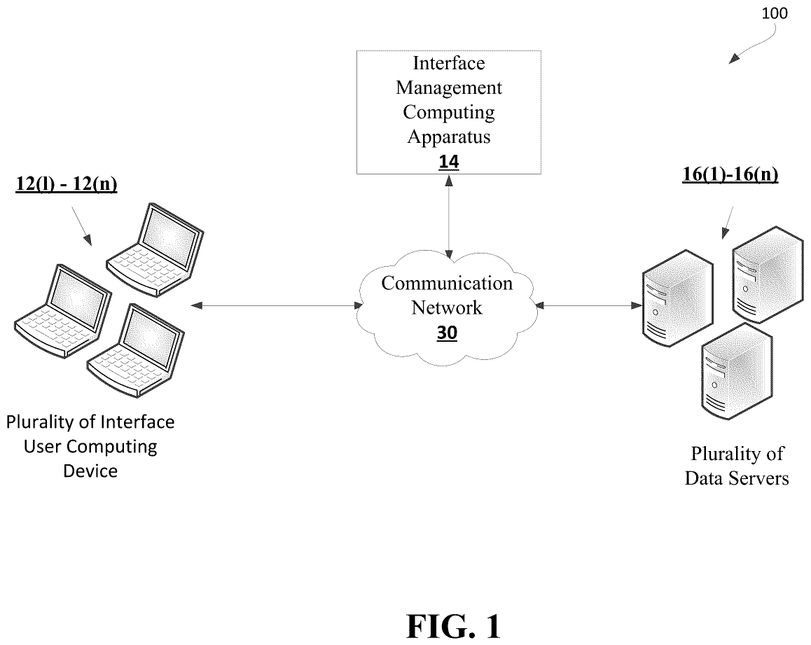

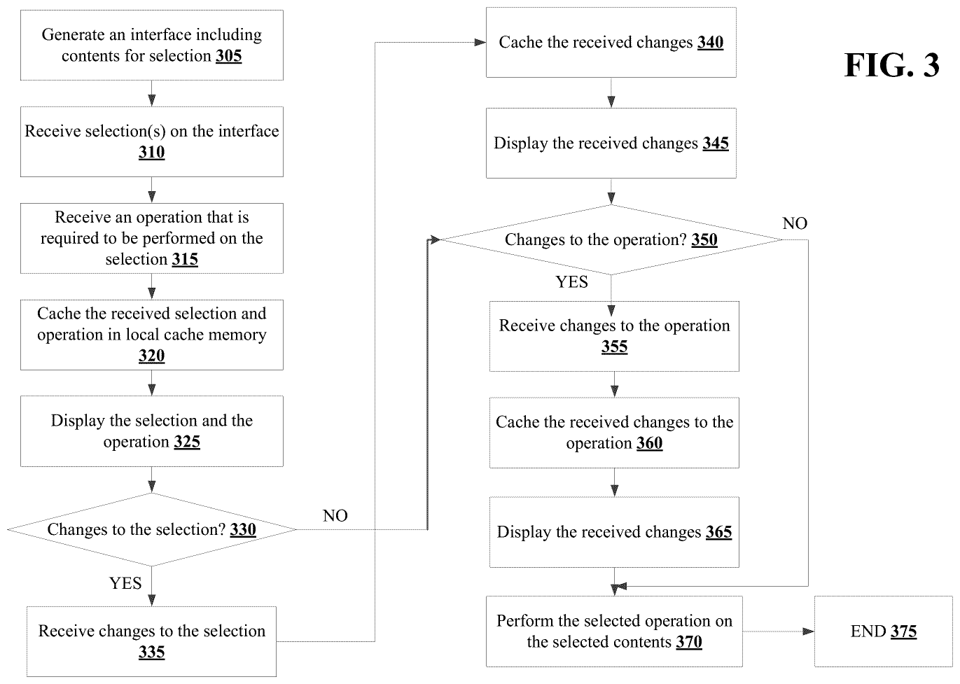

FIG. 1 shows a network environment 100 with an example of an interface management computing apparatus 14. Briefly, the interface management computing apparatus 14 generates graphical user interfaces for display on a plurality of user computing devices 12(1)-12(n) based on content provided by a plurality of data servers 16(1)-16(n). Assume that a user at one of the user computing devices 12(1)-12(n) wishes to perform an operation on one or more content items in the graphical user interface. This operation may be, for example, copying, deleting, renaming, or moving the content items. The user selects the content items and accesses a dialog box (e.g., via a right click) that lists actions that can be performed on the selected content. Prior to or concurrent with display of the dialog box, the user's selections are transmitted to the interface management computing apparatus 14 where they are cached. If the user then cancels the operation, the user's selections remain cached for a pre-determined time period (e.g., 30 seconds). The user may then make additional or alternative selections of a content item. Once the user completes the request of the operation via the dialog box, the request is performed on the cached content items and any additional selections provided subsequent to caching. This process is described in further detail below with respect to FIGS. 3-5.

In the example of FIG. 1, the network environment 100 includes a plurality of user computing devices 12(1)-12(n), the interface management computing apparatus 14, and the plurality of data servers 16(1)-16(n) connected through a communication network 30, although the environment could include other types and numbers of systems, devices such as server devices, components, and/or other elements as is generally known in the art and will not be illustrated or described herein. This technology provides a number of advantages including providing methods, non-transitory computer readable medium, and apparatuses that provides dynamic selection of contents in a graphical user interface.

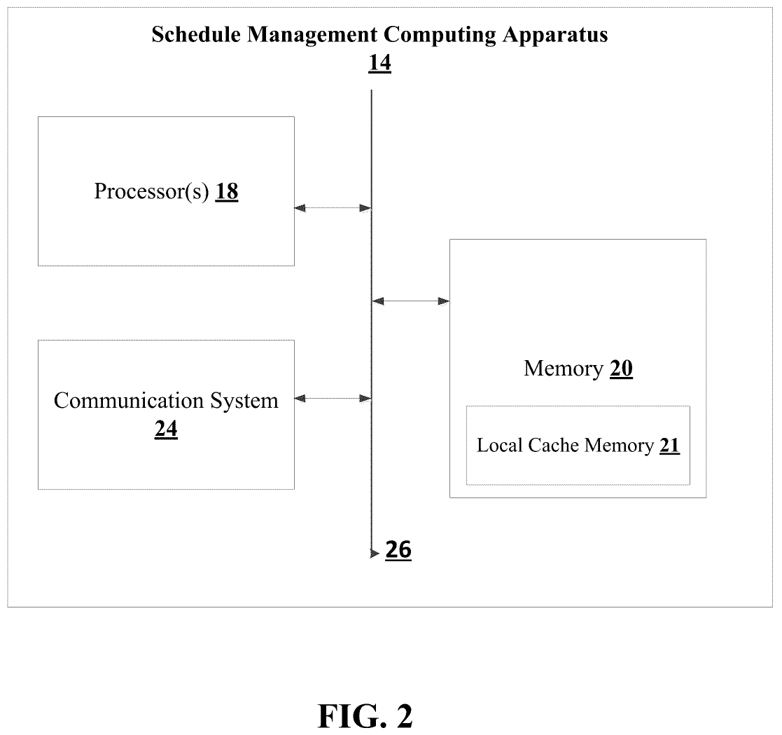

FIG. 2 provides additional detail regarding the interface management computing apparatus 14. The interface management computing apparatus 14 is programmed to assist with providing dynamic selection of contents in a graphical user interface, although the apparatus can perform other types and/or numbers of functions or other operations and this technology can be utilized with other types of claims. In this particular example, the interface management computing apparatus 14 includes a processor 18, a memory 20, and a communication system 24 which are coupled together by a bus 26, although the interface management computing apparatus 14 may comprise other types and/or numbers of physical and/or virtual systems, devices, components, and/or other elements in other configurations.

The processor 18 in the interface management computing apparatus 14 may execute one or more programmed instructions stored in the memory 20 for providing dynamic selection of contents in a graphical user interface as illustrated and described in the examples herein, although other types and numbers of functions and/or other operations can be performed. The processor 18 in the interface management computing apparatus 14 may include one or more central processing units and/or general purpose processors with one or more processing cores, for example.

The memory 20 in the interface management computing apparatus 14 stores the programmed instructions and other data for one or more aspects of the present technology as described and illustrated herein, although some or all of the programmed instructions could be stored and executed elsewhere. A variety of different types of memory storage devices, such as a random access memory (RAM) or a read only memory (ROM) in the system or a floppy disk, hard disk, CD ROM, DVD ROM, or other computer readable medium which is read from and written to by a magnetic, optical, or other reading and writing system that is coupled to the processor 18, can be used for the memory 20. Further, as illustrated in FIG. 2, the memory 20 includes a local cache memory 21 that can be used to quickly and efficiently temporarily store the selections of the content and the operation made by the user computing devices 12(1)-12(n), although the local cache memory 21 can be used to store other types or amounts of data.

The communication system 24 in the interface management computing apparatus 14 operatively couples and communicates between plurality of user computing devices 12(1)-12(n), which are all coupled together by the communication network 30 shown in FIG. 1, although other types and numbers of communication networks or systems with other types and numbers of connections and configurations to other devices and elements. By way of example only, the communication network 30 can use TCP/IP over Ethernet and industry-standard protocols, including NFS, CIFS, SOAP, XML, LDAP, SCSI, and SNMP, although other types and numbers of communication networks, can be used. The communication network 30 in this example may employ any suitable interface mechanisms and network communication technologies, including, for example, any local area network, any wide area network (e.g., Internet), teletraffic in any suitable form (e.g., voice, modem, and the like), Public Switched Telephone Network (PSTNs), Ethernet-based Packet Data Networks (PDNs), and any combinations thereof and the like.

In the example shown in FIGS. 1 and 2, each of the user computing devices 12(1)-12(n) may request or view the contents of the graphical user interface managed by the interface management computing apparatus 14, although the user computing devices 12(1)-12(n) can interact with the interface management computing apparatus 14 for other purposes. Each of the user computing devices 12(1)-12(n) may include a processor, a memory, user input device, such as a keyboard, mouse, and/or interactive display screen by way of example only, a display device, and a communication interface, which are coupled together by a bus or other link, although each may have other types and/or numbers of other systems, devices, components, and/or other elements.

Each of the plurality of data servers 16(1)-16(n) includes a central processing unit (CPU) or processor, a memory, and a communication system, which are coupled together by a bus or other link, although other numbers and/or types of network devices could be used. Generally, the plurality of data servers 16(1)-16(n) provides the data necessary to create and provide dynamic selection of contents in a graphical user interface to the interface management computing apparatus 14, via the communication network 30 according to the HTTP-based application RFC protocol or the CIFS or NFS protocol in this example, but the principles discussed herein are not limited to this example and can include other application protocols. A series of applications may run on the data servers 16(1)-16(n) that allows the transmission of data requested by the user computing devices 12(1)-12(n), or the interface management computing apparatus 14. It is to be understood that the plurality of data servers 16(1)-16(n) may be hardware or software or may represent a system with multiple external resource servers, which may include internal or external networks. In this example the plurality of data servers 16(1)-16(n) may be any version of Microsoft® IIS servers or Apache® servers, although other types of servers may be used.

Although the exemplary network environment 10 with the interface management computing apparatus 14, the user computing devices 12(1)-12(n), and the plurality of data servers 16(1)-16(n) is described and illustrated herein, other types and numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s). The disclosed technology can be implemented as module or components of another application. Further, the disclosed technology can be implemented as operating system extensions, module, plugins, or the like. The disclosed technology can be implemented as module or components of another application. Even further, the disclosed technology may be operative in a cloud-based computing environment. The disclosed technology can be executed within virtual machine(s) or virtual server(s) that may be managed in a cloud-based computing environment. Also, the disclosed technology, including the interface management computing apparatus 14 itself, may be located in virtual server(s) running in a cloud-based computing environment rather than being tied to one or more specific physical network computing devices. Also, the disclosed technology may be running in one or more virtual machines (VMs) executing on the interface management computing apparatus 14. Additionally, in at least one of the various embodiments, virtual machine(s) running on the interface management computing apparatus 14 may be managed or supervised by a hypervisor.

Although the interface management computing apparatus 14 is illustrated as single device, one or more actions of the interface management computing apparatus 14 may be distributed across one or more distinct computing devices. Moreover, the interface management computing apparatus 14 is not limited to a particular configuration. Thus, the interface management computing apparatus 14 may contain a plurality of computing devices that operate using a master/slave approach, whereby one of the computing device of the interface management computing apparatus 14 operate to manage and/or otherwise coordinate operations of the other network computing devices. The interface management computing apparatus 14 may operate as a plurality of network computing devices within cluster architecture, a peer-to peer architecture, virtual machines, or within a cloud architecture.

Thus, the technology disclosed herein is not to be construed as being limited to a single environment and other configurations and architectures are also envisaged. For example, the interface management computing apparatus 14 in FIGS. 1 and 2 can operate within other computing devices (not shown) rather than as a stand-alone computing device.

While the interface management computing apparatus 14 is illustrated in this example as including a single device, the interface management computing apparatus 14 in other examples can include a plurality of devices or blades each with one or more processors, each processor with one or more processing cores that implement one or more steps of this technology. In these examples, one or more of the devices can have a dedicated communication interface or memory. Alternatively, one or more of the devices can utilize the memory, communication interface, or other hardware or software components of one or more other communicably coupled of the devices. Additionally, one or more of the devices that together comprise interface management computing apparatus 14 in other examples can be standalone devices or integrated with one or more other devices or applications, for example. Moreover, one or more of the devices of the interface management computing apparatus 14 in these examples can be in a same or a different communication network including one or more public, private, virtual or cloud networks, for example.

One or more of the components depicted in the network environment 10, such as the interface management computing apparatus 14, for example, may be configured to operate as virtual instances on the same physical machine. In other words, the interface management computing apparatus 14 illustrated in FIG. 1 may operate on the same physical device rather than as separate devices communicating through a network as depicted in FIG. 1.

In addition, two or more computing systems or devices can be substituted for any one of the systems or devices in any example. Accordingly, principles and advantages of distributed processing, such as redundancy and replication also can be implemented, as desired, to increase the robustness and performance of the devices, apparatuses, and systems of the examples. The examples may also be implemented on computer system(s) that extend across any suitable network using any suitable interface mechanisms and traffic technologies, including by way of example, only teletraffic in any suitable form (e.g., voice and modem), wireless traffic media, wireless traffic networks, cellular traffic networks, G3 traffic networks, Public Switched Telephone Network (PSTNs), Packet Data Networks (PDNs), the Internet, intranets, and combinations thereof.

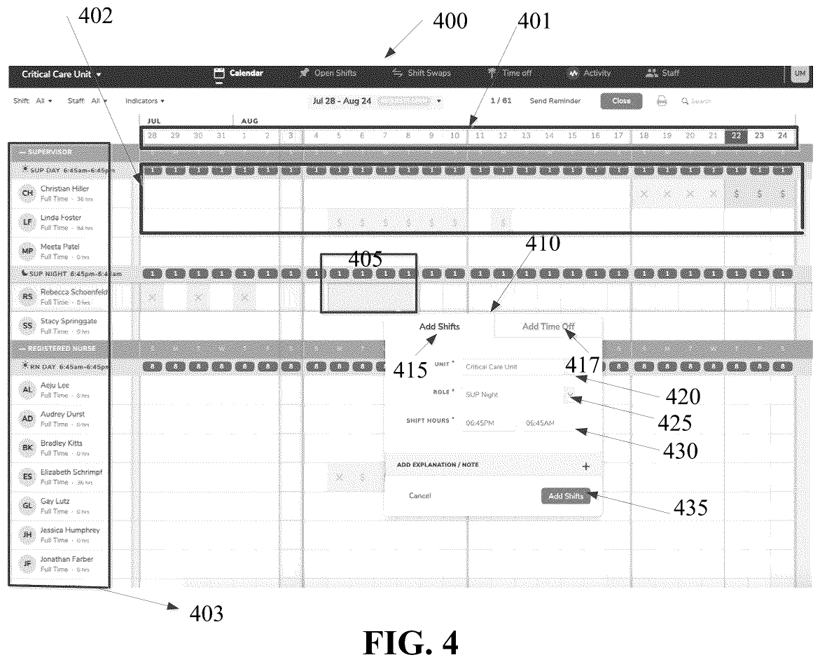

FIG. 3 describes an example method for providing dynamic selection of contents in a graphical user interface, according to some embodiments. The exemplary method begins at step 305, where the interface management computing apparatus 14 generates and provides a graphical user interface comprising contents for selection to one of the user computing devices 12(1)-12(n). By way of example, FIG. 4 illustrates an interface 400 generated by the interface management computing apparatus 14. In this example, the generated interface 400 can include contents such as date field 401, date selection field 402, and list of employees 403, although the generated interface 400 can include other types or amounts of information. In another example, each component displayed in the generated interface 400 could be generated and displayed on multiple interfaces (not shown). Further, the interface management computing apparatus 14 may retrieve the data for the contents in the generated interface from the plurality of data servers 16(1)-16(n), although the data can be retrieved from other locations.

Next in step 310, the interface management computing apparatus 14 receives one or more selections of the components on the generated interface by one of the user computing devices 12(1)-12(n). By way of example, the interface management computing apparatus 14 receives a selection of the days field 405 in the generated interface 400 from one of the user computing devices 12(1)-12(n), although the interface management computing apparatus 14 can receives selection(s) of other contents within the generated interface 400.

In step 315, the interface management computing apparatus 14 receives an operation that is required to be performed on the received selection. In this example, when the interface management computing apparatus 14 receives the selection of days field 405, a dialog box 410 is generated and displayed on the interface 400. The dialog box 410 includes multiple operations such as adding shifts 415 and adding time off 417, although the dialog box 410 can include other types of operations. Ideally, the dialog box 410 should not obscure any content displayed in the graphical user interface. In some embodiments, the interface management computing apparatus 14 determines whether there is any content beneath the dialog box. If so, the interface management computing apparatus 14 dynamically adjusts the transparency of the dialog box 410 to allow for display of all of the content.

Additionally, upon receiving the operation that is required to be performed, the interface management computing apparatus 14 receives additional data for the operation such as unit data 420, role data 425, shift hours data 430, and adding the selected shifts 435 from one of the user computing devices 12(1)-12(n), although the interface management computing apparatus 14 can receive other types or amounts of additional data. In another example, the number of types of operations that are provided can depend on the role of a user using the one of the user computing devices 12(1)-12(n). Alternatively, the interface management computing apparatus 14 can enable or disable the operations that can be performed based on the role of a user using the one of the user computing devices 12(1)-12(n). By way of example, if the user using one of the user computing devices 12(1)-12(n) is an employee, then the interface management computing apparatus 14 can provide both the operations of adding shifts 415 and adding time off 417. However, if the user using one of the user computing devices 12(1)-12(n) is a supervisor, then the interface management computing apparatus 14 can disable the operation of adding time off 417 for an employee and simply provide an operation of adding shift 415.

Next in step 320, the interface management computing apparatus 14 caches the received selection of the contents and the selected operation within the local cache memory 21 present within the memory 20, although the interface management computing apparatus 14 can store the received selection of the contents and the selected operation at other memory locations. By caching the received selection of the contents and the selected operation in the local cache memory, the disclosed technology is able to retain the selections of the contents and the operation for any subsequent changes that would be required.

In step 325, the interface management computing apparatus 14 displays the received selection of the contents (day field 405) and the operation (adding shifts 415) as illustrated in the generated interface 400 of FIG. 4.

In step 330, the interface management computing apparatus 14 determines if one or more changes required to be made to the received selection of the contents. In this example, the interface management computing apparatus 14 can receive a prompt from one of the user computing devices 12(1)-12(n) by clicking on the contents displayed in the generated interface 400. Based on the prompt received from one of the user computing devices 12(1)-12(n), the interface management computing apparatus 14 can determine that changes are required to the selection that was received in step 310, although the interface management computing apparatus 14 can use other techniques to make the determination. Accordingly, when the interface management computing apparatus 14 determines that no changes are required for the selected contents (determined either by not receiving a prompt or by receiving a selection of add shift 435), then the No branch is taken to step 350 which will be further illustrated below. However, when the interface management computing apparatus 14 determines that one or more changes are required, then the Yes branch is taken to step 335.

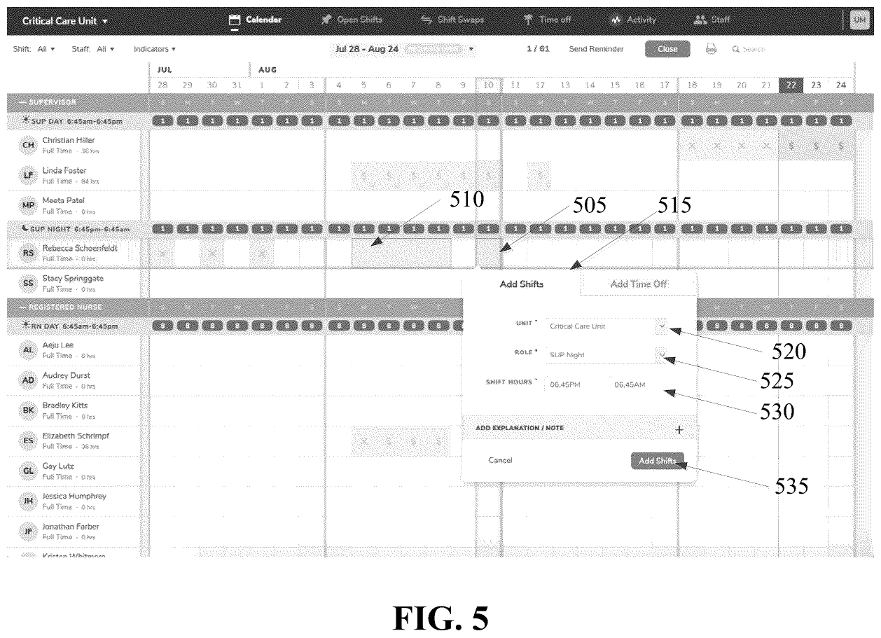

In step 335, the interface management computing apparatus 14 receives one or more changes to the selection of the content that was previously made in step 315. By way of example, the interface management computing apparatus 14 receives a selection of an additional day field 505 represented in FIG. 5 from one of the user computing devices 12(1)-12(n), although the interface management computing apparatus 14 can receive other types of changes. In this example, additional day field 505 represents the change that was received, previously selected day fields 510 represents the selection that was previously made (as illustrated in step 315 and day field 405 in FIG. 4), and dialog box 515 represents the dialog box that is continued to be displayed from the previous selection (received in step 315 and as illustrated in dialog box 410 in FIG. 4).

In step 340, the interface management computing apparatus 14 caches the received one or more changes within the local cache memory in the memory 20, although the interface management computing apparatus 14 can store the received changes at other memory locations.

In step 345, the interface management computing apparatus 14 displays the received changes while retaining the previous selection that was displayed in step 325. In this example, the interface management computing apparatus 14 uses the data present in the local cache memory 21 (that was previously selected in step 310 and displayed in step 325) to retain the previously selected content on the display while displaying the received changes. By way of example, the interface management computing apparatus 14 retains the previously selected day fields 510 represented in FIG. 5 while also displaying the additional day field 505 (change received in step 335). By using the above illustrated technique, the disclosed technology displays the received changes while retaining previous selection of contents thereby avoiding the need for one of the user computing devices 12(1)-12(n) to again make the same selection. In other words, the user computing devices 12(1)-12(n) need not re-select the day fields that were previously selected simply to make a change (i.e., selecting a new day field).

Next in step 350, the interface management computing apparatus 14 determines if there are any changes to the operation. In this example, the interface management computing apparatus 14 can receive a prompt from one of the user computing devices 12(1)-12(n) by clicking on the dialog box 515 illustrated in FIG. 5. Based on the prompt received from one of the user computing devices 12(1)-12(n), the interface management computing apparatus 14 can determine that changes are required to the selection that was received in step 315, although the interface management computing apparatus 14 can use other techniques to make the determination. Accordingly, when the interface management computing apparatus 14 determines that no changes are required for the selected contents (determined either by not receiving a prompt or by receiving a selection of add shift 535), then the No branch is taken to step 370 which will be further illustrated below. However, when the interface management computing apparatus 14 determines that one or more changes are required, then the Yes branch is taken to step 355.

In step 355, the interface management computing apparatus 14 receives one or more changes to the operation that was previously received in step 315. By way of example, the interface management computing apparatus 14 can receive changes to the unit data field 520, the role data field 525 and/or the shift hours data field 535 represented in FIG. 5. In another example, the interface management computing apparatus 14 can either provide additional operations or reduce the operations provided in the dialog box 515 based on the changes that was received to the previously selected content (as illustrated in step 335, if any). In yet another example, the interface management computing apparatus 14 can retain the operations previously received for the previously selected content and can provide a separate operation exclusively for the changes received to the selected content within the same dialog box 515.

Next in step 360, the interface management computing apparatus 14 caches the received changes to the operation within the local cache memory 21, although the interface management computing apparatus 14 can store the changes at other memory locations.

In step 365, the interface management computing apparatus 14 displays the received changes to the operation while retaining the previous selection of the content received in step 315 along with the one or more changes to the content (if any). By way of example, the interface management computing apparatus 14 displays the dialog box 515 with the received changes to the operation while continuing to display the previously selected day fields 510 and the additional day field 505. In other words, the interface management computing apparatus 14 does not close and reopen a new dialog box to display the changes to the operation that was received in step 365.

Next, in step 370, the interface management computing apparatus 14 performs the selected operation on the selected contents. In this example, the interface management computing apparatus 14 can perform the selected operation after receiving a prompt from one of user computing devices 12(1)-12(n), although the interface management computing apparatus 14 can perform the selected operation without receiving the prompt. By way of example, the interface management computing apparatus 14 proceeds to add a shift for the previously selected day field 510 and the newly received additional day field 505 upon receiving a selection of add shifts 535 (prompt) from one of the user computing devices 12(1)-12(n). By performing the selected operation after displaying, the disclosed technology provides a responsive graphical user interface experience to the user computing devices by avoiding any potential delay in displaying the outcome of the operation. In other words and by way of example, the user computing devices need not have to wait until the selected operation of adding a new shift is performed before viewing the days and time on which the shift is added. The exemplary method ends at step 375.

It should be noted that the computing architecture discussed above with respect to FIGS. 1-3 is merely one example of the architecture that can be used to perform the techniques described herein. For example, the discussion presented above assumes a “cloud” based implementation, where processing is performed primarily by an interface management computing apparatus that is remote from the user computing device. However, in other embodiments, some or all of the functionality performed by the interface management computing apparatus may be performed locally by the user computing device. In other embodiments a combination of local and remote processing can be employed. For example, content selections can be cached locally at the user computing device, and periodically synched with a cached at the interface management computing apparatus.

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Unless stated otherwise as apparent from the following discussion, it will be appreciated that terms such as “applying,” “generating,” “identifying,” “determining,” “processing,” “computing,” “selecting,” or the like may refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices. Embodiments of the methods described herein may be implemented using computer software. If written in a programming language conforming to a recognized standard, sequences of instructions designed to implement the methods can be compiled for execution on a variety of hardware platforms and for interface to a variety of operating systems. In addition, embodiments of the present invention are not described with reference to any particular programming language. It will be appreciated that a variety of programming languages may be used to implement embodiments of the present invention.

A “graphical user interface” (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112(f) the element is expressly recited using the phrase “means for.”

1. A method for providing dynamic selection in a graphical user interface, the method comprising:
displaying, by a computing device, one or more selections of content data and an operation to be performed on the one or more selections of the content data, on the graphical user interface;
caching, by the computing device, the one or more selections of the content data;
receiving, by the computing device, one or more changes to the displayed one or more selections of content data; and
displaying, by the computing device, the received one or more changes while retaining the displayed one or more selections of the content data and the operation to be performed on the displayed one or more selections of the content data, on the graphical user interface, wherein the cached one or more selections of the content data is used to display the received one or more changes while retaining the displayed one or more selections of the content data.

2. The method as set forth in claim 1 further comprising, caching, by the computing device, the operation to be performed.

3. (canceled)

4. The method as set forth in claim 1 further comprising, performing, by the computing device, the operation after displaying the received one or more changes while retaining the displayed one or more selections of the content data.

5. The method as set forth in claim 1 further comprising, caching, by the computing device, the received one or more changes prior to displaying the received one or more changes while retaining the displayed one or more selections of the content data and the operation to be performed on the displayed one or more selections of the content data.

6. The method as set forth in claim 1 further comprising:
receiving, by the computing device, one or more operation changes to the operation to be performed on the one or more selections of the content data; and
displaying, by the computing device, the received one or more operation changes while retaining the display of the received one or more changes and the display of the one or more selections of the content data.

7. A non-transitory computer readable medium having stored thereon instructions for providing dynamic selection of contents in a graphical user interface comprising executable code, which when executed by at least one processor, cause the processor to:
display one or more selections of content data and an operation to be performed on the one or more selections of the content data, on the graphical user interface;
caching the one or more selections of the content data;
receive one or more changes to the displayed one or more selections of content data; and
display the received one or more changes while retaining the displayed one or more selections of the content data and the operation to be performed on the displayed one or more selections of the content data, on the graphical user interface, wherein the cached one or more selections of the content data is used to display the received one or more changes while retaining the displayed one or more selections of the content data and the operation to be performed.

8. The medium as set forth in claim 7 further comprising, caching the operation to be performed.

9. (canceled)

10. The medium as set forth in claim 7 further comprising, performing the operation after displaying the received one or more changes while retaining the displayed one or more selections of the content data.

11. The medium as set forth in claim 7 further comprising, caching the received one or more changes prior to displaying the received one or more changes while retaining the displayed one or more selections of the content data and the operation to be performed on the displayed one or more selections of the content data.

12. The medium as set forth in claim 7 further comprising:
receiving one or more operation changes to the operation to be performed on the one or more selections of the content data; and
displaying the received one or more operation changes while retaining the display of the received one or more changes and the display of the one or more selections of the content data.

13. A computing device comprising:
a processor; and
a memory coupled to the processor which is configured to be capable of executing programmed instructions comprising and stored in the memory to:
display one or more selections of content data and an operation to be performed on the one or more selections of the content data, on a graphical user interface;
cache the one or more selections of the content data;
receive one or more changes to the displayed one or more selections of content data; and
display the received one or more changes while retaining the displayed one or more selections of the content data and the operation to be performed on the displayed one or more selections of the content data, on the graphical user interface, wherein the cached one or more selections of the content data is used to display the received one or more changes while retaining the displayed one or more selections of the content data and the operation to be performed.

14. The device as set forth in claim 13 wherein the processor is further configured to be capable of executing the stored programmed instructions to cache the operation to be performed.

15. (canceled)

16. The device as set forth in claim 13 wherein the processor is further configured to be capable of executing the stored programmed instructions to perform the operation after displaying the received one or more changes while retaining the displayed one or more selections of the content data.

17. The device as set forth in claim 13 wherein the processor is further configured to be capable of executing the stored programmed instructions to cache the received one or more changes prior to displaying the received one or more changes while retaining the displayed one or more selections of the content data and the operation to be performed on the displayed one or more selections of the content data.

18. The device as set forth in claim 13 wherein the processor is further configured to be capable of executing the stored programmed instructions to:
receive one or more operation changes to the operation to be performed on the one or more selections of the content data; and
display the received one or more operation changes while retaining the display of the received one or more changes and the display of the one or more selections of the content data.
